(19) United States
(12) Patent Application Publication
(10) Pub. No.: US 2013/0041626 A1
(43) Pub. Date: Feb. 14, 2013

(54) Hybrid Analysis of Emerging Trends for Process Control

(71) Applicants: Aaron D. Civil, Rochester, MN (US); Jeffrey G. Komatsu, Kasson, MN (US); Andrew Soon Ng Yong Liang, Singapore (SG); John M. Wargo, Poughkeepsie, NY (US); Emmanuel Yashchin, Yorktown Heights, NY (US); Paul A. Zulpa, Woodbury, CT (US)

(72) Inventors: Aaron D. Civil, Rochester, MN (US); Jeffrey G. Komatsu, Kasson, MN (US); Andrew Soon Ng Yong Liang, Singapore (SG); John M. Wargo, Poughkeepsie, NY (US); Emmanuel Yashchin, Yorktown Heights, NY (US); Paul A. Zulpa, Woodbury, CT (US)

(73) Assignee: INTERNATIONAL BUSINESS MACHINES CORPORATION, Armonk, NY (US)

(21) Appl. No.: 13/409,971

(22) Filed: Mar. 1, 2012

Related U.S. Application Data
(63) Continuation of application No. 13/207,422, filed on Aug. 11, 2011.

(51) Int. Cl. G06F 17/18; G06F 15/00

(52) U.S. Cl. 702/179; 702/186

(57) ABSTRACT

An asymmetric approach is used for evaluating process control data, whereby one approach is used for determining entry into the emerging life cycle phase (i.e., presence of a new defect) and a different approach is used for detecting entry into the other life cycle phases such as cresting and recovering. An evidence curve is created from observed instance data for a particular defect, and the slope of this evidence curve is analyzed programmatically by applying one or more tests, in combination with sequential time-reversed estimation, to determine return-to-normal conditions with a desired level of confidence.

### CROSS-REFERENCE TO RELATED APPLICATION

The present invention is related to commonly-assigned and co-pending application Ser. No. 13/207,425, which is titled “Advanced Statistical Detection of Emerging Trends” (Attorney Docket AUS920110187US1). This application, which is referred to hereinafter as “the related application”, was filed on Aug. 11, 2011 and is incorporated herein by reference.

### BACKGROUND

The present invention relates to process control, and deals more particularly with using hybrid analysis of emerging trends for process control.

In today's high-velocity business climate, supply chains are becoming more complex and inventory moves at a rapid pace. Accordingly, supply chains are becoming more vulnerable to out-of-control conditions which can adversely affect product quality, supply, and cost.

### BRIEF SUMMARY

The present invention is directed to analyzing trends in a process control environment. In one aspect, this comprises: determining, by applying at least one defect-detecting analysis scheme to first observed process control data for a process entity, when the process entity exhibits a defect during a process; and determining, by applying at least one recovery-detecting analysis scheme to second observed process control data for the process entity, whether the process entity is recovered from the defect. The defect-detecting analysis scheme may comprise determining a slope of an evidence curve created from the first process control data and determining that the process entity exhibits the defect during the process when the slope increases beyond a predetermined confidence level. The recovery-detecting analysis scheme may further comprise determining a point in time where the second observed process control data trends toward recovery from the defect, and more particularly, may comprise analyzing the second observed process control data for a time period following the determined point in time to determine if the process entity is recovered from the defect. The time period may comprise an interval from the determined point in time to a current time, and the analyzing may further comprise: creating a plurality of sequences from the second observed process control data to compute a parameter value, over a period extending backwards from the current time to the point in time, each of the sequences corresponding to a different subset of the interval and extending backwards from the current time to a successively earlier (i.e., sequentially earlier) point during the interval; and analyzing, using each of the plurality of sequences, a subset of the second process control data to compute the parameter value for the subset, each of the subsets of the second process control data representing process control data observed during the subset of the time interval that corresponds to the sequence.

Embodiments of these and other aspects of the present invention may be provided as methods, systems, and/or computer program products. It should be noted that the foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

### BRIEF DESCRIPTION OF THE SEVERAL VIEWS OF THE DRAWINGS

The present invention will be described with reference to the following drawings, in which like reference numbers denote the same element throughout.

FIG. 1 illustrates a defect life cycle graph;

FIGS. 2-3 and 5 provide flowcharts depicting logic which may be used when implementing an embodiment of the present invention;

FIG. 4 illustrates making a decision about whether a set of data is better explained as being an unacceptable process level than as being an acceptable process level, and accordingly, not representing a return to normal; and

FIG. 6 depicts a data processing system suitable for storing and/or executing program code.

### DETAILED DESCRIPTION

In today's business climate, supply chains are becoming more vulnerable to out-of-control conditions which can adversely affect product quality, supply, and cost. Businesses will therefore benefit from early detection of problems and by quickly containing suspect inventory, which in turn enables the business to reduce costs associated with taking remedial actions.

Businesses typically rely upon long-established methodologies for process control, such as the so-called “Western Electric” analysis, yield/trend, performance versus target methodology, and other well-known statistical detection methods that are directed toward measuring and controlling process quality. Statistical process control is generally recognized as the best method for maintaining a process on target, and with low variability, within a supply chain environment. Statistical process control is also generally recognized as a good means of detecting emerging issues within a process. However, while known techniques are suitable to a certain degree for identifying and controlling emerging and/or existing process problems, these techniques have limitations.

One limitation of known statistical process control techniques is that such techniques are not well suited for detecting, in an automated manner, which phase of the defect life cycle a problem is currently in. Known statistical process control techniques also do not provide adequate means for gauging very early signs of recovery after an excursion has occurred. (The term “excursion”, as used herein, refers to a detected increase in occurrence of a defect.)

Known techniques for statistical process control are typically used in a piecemeal manner, whereby a single measure is used at a time. Evidence obtained by one technique is often excluded, ignored, or unavailable for use by other techniques. This lack of information-sharing across techniques also means that valuable data are lost or, at best, underutilized. And, even if the evidence obtained with one technique is available to other techniques, the users of the statistical process control techniques have no known systematic means for cross-referencing the evidence among the various techniques to create a holistic view of a particular defect.

If a defect remediation has already successfully addressed a defect, time and resources are generally wasted by continuing the defect remediation. Alternatively, remediation methods that do not address the defect may be performed long after evidence that they are ineffective is available. The lack of cross-referencing and synergy in known statistical process control techniques prevents quality control practitioners and processes from making an early determination as to whether a particular defect remediation is having the desired effect. To avoid wasteful remediation processing in such circumstances, it is desirable to have timely and continuing feedback on the direction of movement in defect trending.

While traditional methods of statistical process control may be well suited for detecting negative trends in process quality (i.e., detecting when a defect has potentially occurred), these known methods are not directed to detecting or estimating positive trends. In addition, they are not directed to determining whether an already-identified defect is cresting or is recovering (as will be discussed in further detail below).

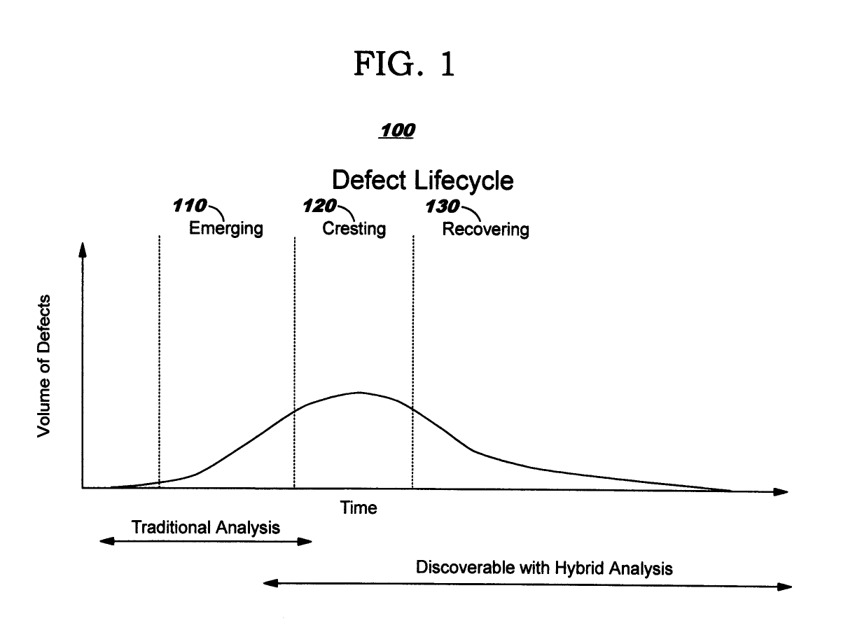

An embodiment of the present invention provides an automated, data-driven analysis of process control data to determine the current life cycle phase of a defect. The most-recent process control data are used for programmatically determining the current phase of the defect, including when the defect moves from one life cycle phase to another. By way of illustration but not of limitation, potential phases within a defect life cycle are referred to herein as emerging, cresting, and recovering. See FIG. 1, where these phases are illustrated at 110, 120, and 130, respectively, for the sample graph 100. The emerging phase occurs when a defect is detected but has not yet begun to stabilize. A defect in the cresting phase, as that term is used herein, is a defect in which the volume of detected occurrences has reached a peak and has begun to improve (i.e., to decrease in volume). Cresting typically occurs at some point after defect remediation efforts have begun. The recovering phase of the life cycle occurs when remediation efforts are largely complete, and the supply chain is rebounding to a stable, non-defective period.

An embodiment of the present invention makes possible the composition of data from disparate quality analysis techniques, enabling quality control processes to determine whether a defect has progressed from emerging and is now in the cresting or recovering phase of the life cycle. By determining that a defect has crested or is recovering, the quality control practitioners and practices are better able to react appropriately. Detecting that a defect is in recovery, for example, means that a process control organization has implemented sufficient process changes to remediate the defect, and that remaining focus is more appropriately directed to other tasks such as completing the implementation inventory (i.e., the inventory to which the remediation actions have been applied to address this previously out-of-control situation) or providing remediation for other defects. Making a timely change to the remediation efforts in this manner may add up to significant savings in time, resources, and/or lost revenue.

An embodiment of the present invention uses advanced statistical techniques as described herein, combining those techniques with business rules and supplemental criteria that are tuned for early detection of recovery. In this manner, an embodiment of the present invention tests whether the process is coming under control after having determined that a defect is past the emerging phase of the life cycle. In another embodiment, statistical methods are used in conjunction with supplemental criteria, but without use of business rules input. Multiple secondary tests may be used in an embodiment to determine whether a negative defect slope is, in fact, a positive indicator of process control stabilization or is instead a false positive. The secondary tests are designed such that passing the tests for a particular already-detected defect is an indicator that it is likely that this defect is in the cresting phase. The secondary tests are applied again, using different criteria, to detect when the defect has entered the recovering phase, and supplemental measures are used to verify that the defect is exhibiting a positive trend and to confirm that the supply chain is returning to normal. An embodiment of the present invention is directed toward determining when a process “goes bad”, and because this may happen in multiple ways which have differing symptoms, use of multiple tests increases the likelihood of discovering a defect and/or changes in the process following occurrence of a defect. The set of tests which are applied may vary, depending on the detected phase of the defect, and tests may be executed in series, or in parallel, and/or iteratively to evaluate process control data. In addition, a prediction may be made as to when the process will return to normal. Responsive to detecting the return to normal, measures for the process control function can be reset, so that (for example) they may begin accumulation of evidence for a different defect.

More particularly, detecting that a process is coming under control, as evidenced by a positive trend in process control data, indicates a positive correlation between defect remediation efforts and their effect on the process. By detecting the positive correlation, process control practitioners and processes can now determine, much earlier than previously possible, when recovery is complete based on statistical evidence, and this can be done with a low rate of error (i.e., a low occurrence of false positives) and therefore a high level of confidence that a valid result is obtained. Determining when defect recovery is complete may represent a savings in time, cost, and/or resources as remediation efforts can be halted, as noted earlier. Accordingly, an embodiment of the present invention records the details of the remedial action for possible future use, and records a measure of improvement as evidence that the action was indeed effective.

An embodiment of the present invention evaluates the behavior of a defect, in view of the defect life cycle. An evidence curve is created from observed instance data for a particular defect, and the slope of this evidence curve is analyzed programmatically. This analysis comprises application of one or more tests, in combination with sequential time-reversed estimation, to determine return-to-normal conditions with a desired level of confidence, as will be described in more detail hereinafter. The one or more tests may be performed, for example, by using a Likelihood Ratio test or Cusum-Shewhart (where “Cusum” is an abbreviation of “cumulative sum”) Analysis. (The Likelihood Ratio and Cusum-Shewhart methodologies are well known to those of skill in the art, and will not be described in detail herein.)

An embodiment of the present invention may be used with a process control dashboard display to provide information for process control professionals, and information that is generated as disclosed herein may be used for prioritizing problems in the dashboard and/or for presenting information to process control professionals about the status of a defect, such as its current life cycle phase, how much more data is needed and/or how much more time is expected until recovery is achieved if current trends continue, and so forth.

Notably, an embodiment of the present invention uses an asymmetric approach, whereby one approach is used for determining entry into the emerging life cycle phase (i.e., presence of a new defect) and a different approach is used for detecting entry into the other life cycle phases. That is, while an embodiment of the present invention concludes that a defect exists—and therefore begins tracking the defect—using a set of tests which are generally geared to be “easy to pass”, a more stringent approach is used for deciding when the defect is recovered and that it is time to cease the tracking of the defect. This is facilitated by evaluating evidence that a process is good versus evidence that the process is bad. If evidence that the process is bad is greater, then this is declared as the onset of a defect. However, this is not the test used for declaring that the defect is resolved. Instead, evidence that the process is at a good level—that is, that the defect rate is improving due to better process conditions—is used for declaring that a defect is resolved. This analysis is made by analyzing observed process control data over a period of time extending backwards from the current time, as will be discussed in more detail. Accordingly, as noted earlier, an embodiment of the present invention records the details of the remedial action for possible future use, and records a measure of improvement as evidence that the action was indeed effective.

Suppose, for example, that a new part is being produced in a process, and that this new part experiences a high fall-out rate, which is also referred to equivalently herein as the “non-conformance rate” for the product. The part may be represented on a process control dashboard, enabling process control professionals to monitor the part as an embodiment of the present invention tracks and analyzes the ongoing process control data for this part. Upon detecting that the defect for this part is now cresting, i.e., entering a different life cycle phase, the tracking of the defect and the presentation on the dashboard does not end, because recovery from the defect might not be completed just yet. Instead, tracking continues until concluding that the process control data is better explained by a process being good than by the process being bad, and the defect is preferably not removed altogether from the dashboard in the interim but is given a lower priority in terms of display.

A brief review of known techniques will now be provided, which will be followed by a detailed discussion of an embodiment of the present invention.

Typical control schemes in use today detect unfavorable changes in process parameters (but do not assist with recovery detection, as noted earlier). To obtain a control scheme for monitoring the process, a control sequence of statistics is established for every parameter of interest and will serve as a basis for the monitoring scheme. The symbol λ (i.e., lambda) is used herein to refer to a parameter that is to be evaluated, and the notation {Xᵢ}—or equivalently, {X(i)}—is used herein to refer to the control sequence of statistics, where “i” serves as an index having values 1, 2, . . . for this sequence. As an example, a parameter of interest may be the fall-out rate of a process, and a control scheme for monitoring this fall-out rate may be an analysis of defect rates observed in consecutive monitoring intervals. (Monitoring intervals are referred to hereinafter as weeks, for ease of discussion, although it will be apparent that other intervals may be used without deviating from the scope of the present invention.)

A set of weights may be obtained for use with each control sequence. The set of weights may be represented using the notation {wᵢ}—or equivalently, {w(i)}—where each weight w(i) is associated with a corresponding statistic X(i) from the control sequence {X(i)}. As an example, when the parameter is the fall-out rate for a defect, the weights may correspond to sample sizes which are observed in each of the monitoring intervals in order to provide a weighted fall-out rate, where it may be desirable to associate a higher weight with larger sample sizes.

Acceptable and unacceptable regions for performance of the control scheme are established. This is generally represented in the art using the notation λ₀<λ₁, where λₒ represents an acceptable region and λ₁ represents an unacceptable region.

Known techniques then transform the control sequence {X(i)} to a sequence {s(i), i=1, 2, . . . } having the following properties:

(i) s(0)=0

(ii) s(i)=max {0, Ψ(X(i), X(i−1), . . . X(1)} and is non-negative (where Ψ is a function that defines the control scheme)

(iii) If the parameter of interest is in the acceptable region (e.g., λ<λ(0)), then E(s(i)−s(i−1))>0. That is, the process has a positive drift. Stated another way, the expected value, E, of the statistic is greater for monitoring interval s(i) than it was for the previous monitoring interval s(i−1).

(iv) If the parameter of interest is in the unacceptable region (e.g., λ>λ(1)), then E(s(i)−s(i−1))<0. That is, the process has a negative drift. Stated another way, the expected value, E, of the statistic is less for monitoring interval s(i) than it was for the previous monitoring interval s(i−1).

An acceptable probability of false flagging is also established. That is, a determination is made as to what probability is acceptable for flagging a process as being defective when it is actually not defective. In view of this probability, a threshold h, where h>0, is determined for the desired tradeoff between false alarms and the sensitivity of the analysis.

The control scheme is then applied to every relevant data set, and a data set that shows out-of-control conditions, when applying this control scheme, is flagged.

Known techniques typically apply many control sequences in parallel. In some cases, several schemes are used in relation to a given sequence {X(i), i=1, 2, . . . }. For example, one scheme may be applied to detect an increase in the non-conformance rate over the monitoring intervals used in {X(i)}, while a different scheme is applied to detect a decrease in the non-conformance rate over the same monitoring intervals. It may happen that the sequence {X(i), i=1, 2, . . . } has a more complex behavior, whereby for example, all or some of the members of the sequence undergo modification at a new time of observation.

Examples of known techniques that are used in this manner include Cusum, Shewhart, and Cusum-Shewhart schemes; Generalized Likelihood Ratio schemes; Girshik-Rubin schemes; and Weighted Cusum-Shewhart (including Geometrically-Weighted Cusum-Shewhart) schemes.

Supplemental tests may be deployed to enhance ability to detect very recent unfavorable trends. This is the obverse of the approach disclosed in the related application. An embodiment of the present invention uses the configurable measure of evidence, as disclosed in the related application, of the possibility of process control improvement. Once that bar has been met (i.e., once the possibility of improvement is established, to a particular confidence level), an embodiment of the present invention invokes supplemental tests geared towards monitoring and detecting the return to normal of the process.

There may be several candidate starting points which may be used in a data set for determining whether the process is coming under control. An embodiment of the present invention evaluates the trajectory of the “evidence” process that tracks the overall evidence (in terms of control schemes that have proven high statistical power) against the hypothesis that the behavior of the process is acceptable. At the same time, an embodiment of the present invention also utilizes the process of observations in order to achieve the desired level of confidence for declaring a return-to-normal state.

According to an embodiment of the present invention, the evidence processes (i.e., evidence curves) can be computed for one-sided detection or for two-sided detection. In the latter case, two evidence curves are used, one related to the deviation of the process upwards, and another related to the deviation of the process downwards.

Typically, powerful detection procedures (i.e., control schemes) will be used that will trigger alarms (that is, they will flag a given part) if the evidence curve crosses a threshold that is established based on the desired trade-off between the rate of false alarms that may be generated and the sensitivity that is desired in the analysis. Supplemental tests may be added in order to enhance detection capability for recent unfavorable trends.

An embodiment of the present invention make possible the further utilization of the evidence curves (and optionally, related business rules), along with the last relevant segment of observed process control data (as determined through time-reversed estimation), to track phases of the defect development and to make decisions related to the state of the monitored process. In particular, an embodiment of the present invention enables determining, to a particular confidence level, that a process is actually in the recovery phase.

Business rules may be factored into the analysis process in varying ways without deviating from the scope of the present invention. For example, a particular product may be identified for special scrutiny, and the analysis used for this product may be adjusted accordingly—perhaps by increasing the confidence level that is required before declaring a return to normal, or changing the threshold that must be crossed before concluding that a defect exists.

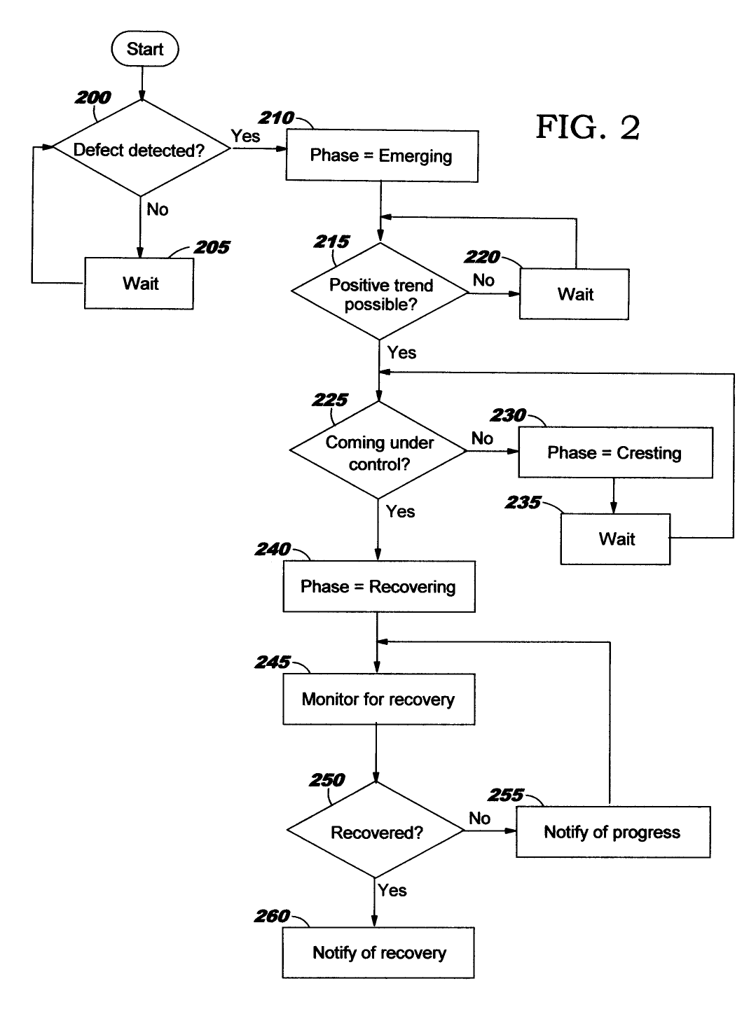

A high-level view of an approach used by a preferred embodiment of the present invention is depicted in FIG. 2, as will now be discussed, and shows an iterative process of analyzing collected process control evidence data for a particular product. Block 200 tests whether analysis of this evidence indicates the presence of a defect. The analyzed data typically corresponds to several monitoring intervals in which process control evidence is obtained (such as multiple weeks of data, when the period for obtaining process control evidence is a week). If this test has a positive result, then processing continues at Block 210. Otherwise, Block 205 implements a waiting period, after which control returns to Block 200 to again test for presence of a defect. The length of the “wait” shown at Block 205 may vary, according to the needs of a particular environment. For example, this waiting period may correspond to a week, if process control data are obtained and analyzed on a weekly basis. Or, if more frequent analysis is performed, then the waiting period may be shorter. Alternatively, a process control professional may be responsible for signaling the end of the waiting period shown at Block 205—for example, by interacting with a process control dashboard interface or other facility that provides a triggering mechanism such as a “Run test for defects” graphical button.

Block 210 sets the phase for the newly-detected defect to “Emerging”. Once a defect has been detected, an embodiment of the present invention begins to monitor for defect trends that signal a return to normal conditions for the process. This monitoring may begin immediately after detecting the defect. Accordingly, Block 215 tests whether there is any evidence that a positive trend is possible in the rate of non-conformance for this defect. If not, then a wait is interposed at Block 220, after which processing returns to Block 215.

It may often happen that it is beneficial to interpose a delay before the monitoring for a return to normal conditions begins. This delay may be due to the need to begin defect diagnostics and remediation after the defect is detected, and in the general case, the need for some period of time to pass before the effects of the defect remediation take effect. Note that typically, at the time of defect detection, there will not be sufficient information to diagnose the defect (e.g., to establish the root cause). This could require actions and additional data that is not provided in the course of monitoring. Accordingly, additional process control evidence is gathered during the waiting period at Block 220, and this evidence will be included in the subsequent analysis of the defect upon the return to Block 215. The wait interval used at Block 220 may be controlled by expiration of a timer or occurrence of an event. (As will be obvious, the wait shown at Block 220 may be interposed prior to, or in addition to, after the test at Block 215 without deviating from the scope of the present invention.) The timer interval may be set by a process control professional, for example, or may be set programmatically. Programmatically setting the timer interval may comprise using a fixed, best-estimate timer interval. Or, a calculation may be performed on observed process control data to set the timer interval. As one example, if the slope of the evidence curve remains positive for each of some determined number of periods (such as each of 4 weeks), then this may be used as an indicator that it is premature to begin monitoring for a return to normal. When an event-based approach is used, the event may comprise the process control professional interacting through a process control dashboard interface or other facility that provides a triggering mechanism such as a “begin monitoring for return to normal” graphical button.

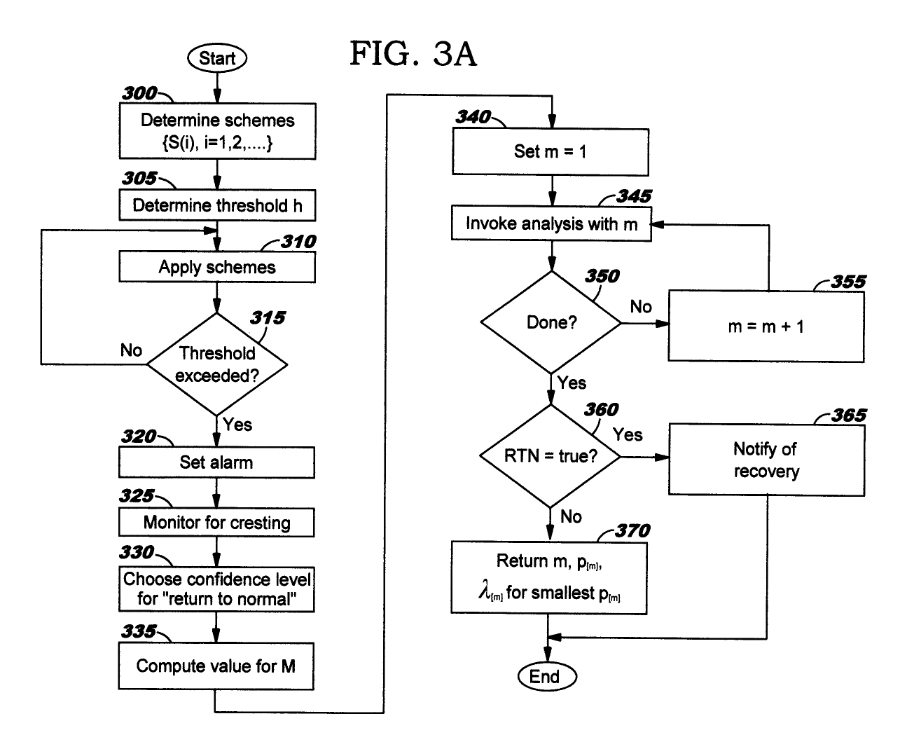

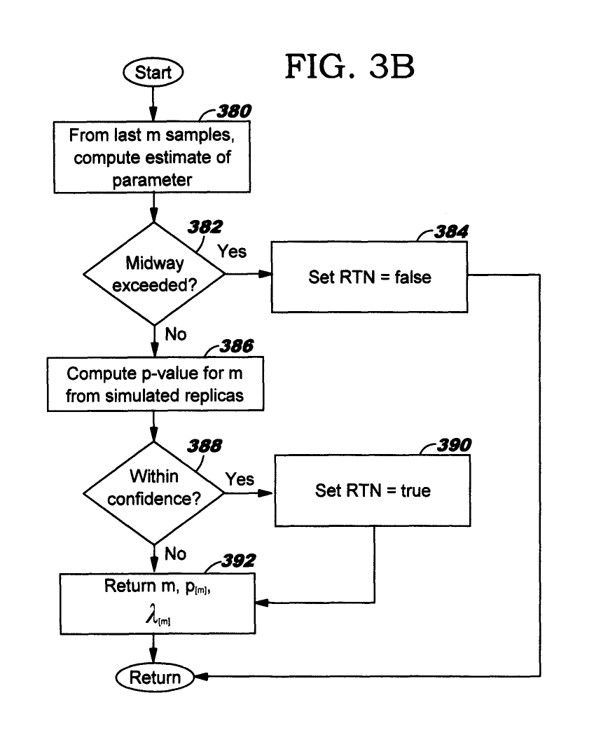

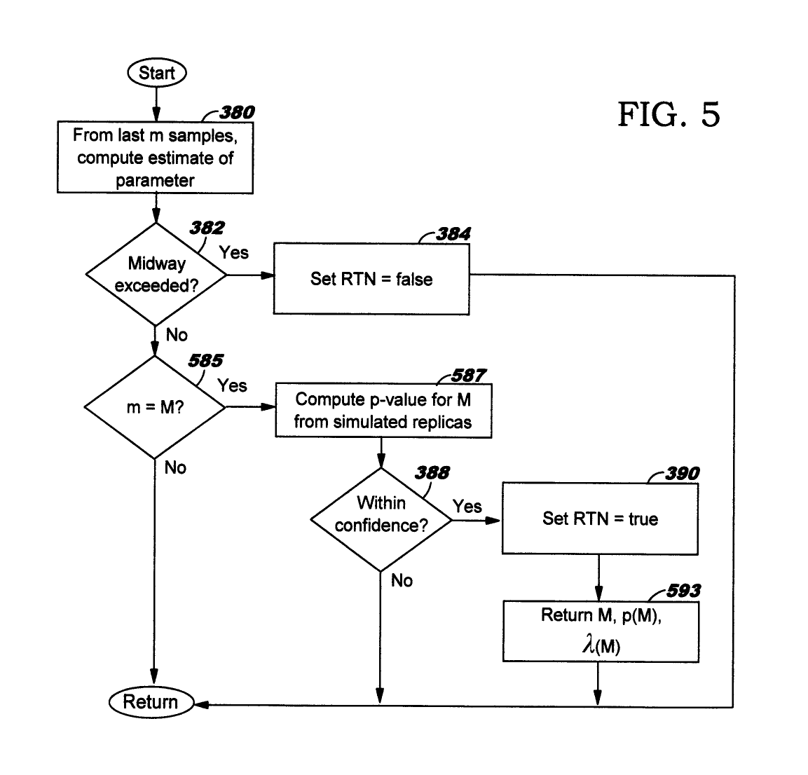

Responsive to Block 215 determining that a positive trend is possible for this defect, processing reaches Block 225, which assesses whether the defect is coming under control. If this test has a positive result, processing continues at Block 240, which sets the phase for this defect to “Recovering”. Otherwise, when the test in Block 225 has a negative result, then Block 230 sets the phase for this defect to “Cresting” because, while a positive trend is possible, the defect is not yet coming under control. Block 235 then implements a delay, prior to returning to Block 225 to continue evaluating whether the process is coming under control, so that the process can continue and additional process control data can accumulate. FIGS. 3 and 5, described below, provide further information on how an embodiment of the present invention may determine that a defect is coming under control.

Once the defect enters the recovering phase, Block 245 monitors for sufficient early evidence that the recovery is complete. FIGS. 3 and 5, described below, provide further information on how an embodiment of the present invention may determine that recovery for a defect may be considered as being complete. When the recovery is determined to be complete, as determined by a positive result at Block 250, control reaches Block 260, which preferably provides a notification—such as an audible alarm, visible message indicator for a process control dashboard, and/or generated internal event—to alert process control practitioners and/or processes of the completion. This notification enables remediation efforts to be halted in a timely and cost-effective manner. An embodiment of the present invention can then begin monitoring for a new defect in the component for which defect recovery and remediation has just completed by newly invoking the iterative processing of FIG. 2. On the other hand, when the test at Block 250 has a negative result, indicating that it is not yet time to declare the process as recovered, then Block 255 preferably reports the degree of recovery. In this manner, the user is given an idea of how much more data is needed and/or how much more time is expected until the recovery is achieved, provided the current trends continue. Optionally, this reported information may be used to change the dashboard display for the defect. For example, an entry may be displayed in a “recovery expected” section of the dashboard, informing the process control professionals that recovery is expected and/or providing the estimated an amount of time until recovery is expected. Processing then returns to Block 245 to continue monitoring the data for evidence of a recovery. (While not shown in FIG. 2, a delay will occur before the analysis of whether recovery is complete is performed again and tested at Block 250, so that additional performance control data can be obtained.)

Turning now to FIG. 3 (comprising FIGS. 3A and 3B), a more detailed view is provided of logic which may be used when implementing an embodiment of the present invention. As shown therein at Blocks 300 and 305, respectively, some number of schemes are determined for analyzing the observed process control data, and a threshold “h” is established. The schemes are then applied to the data, as shown at Block 310. Typically, a control scheme will be run automatically, and no action will be taken as long as the values of the scheme {sᵢ, i=1, 2, . . . } remain below the selected threshold. This is represented at Block 315, which tests whether the threshold was exceeded, and if not, returns control to Block 310 for a subsequent application of the schemes. Refer also to the discussion of schemes and thresholds which was presented above. (As will be obvious, raising the threshold will generally lead to fewer false alarms, but at a cost of sacrificing some detection capability. Business rules may be used to set the threshold may be set in the general case, and/or to adjust the threshold in specific cases.)

An embodiment of the present invention is adapted for using a main scheme as well as optional supplemental schemes. Thus, the test at Block 315 may be triggered in some cases by a supplemental scheme that evaluates a particular parameter of interest, even though the threshold is not exceeded for the main scheme. The main scheme for detecting the presence of a defect may comprise, by way of example, comparing the non-conformance rate observed in one or more periods of process control data to the threshold.

Upon reaching Block 320, the threshold has been exceeded in view of at least one scheme. Block 320 therefore triggers an alarm. This alarm may comprise an audible warning, a visible message indicator for a process control dashboard, and/or a generated internal event to alert process control practitioners and/or processes of the current state of the process. When the current defect phase is not yet set, then this alarm indicates that a defect has been detected.

Once an alarm has been triggered, the monitoring phase for detect detection is generally complete. Some actions for monitoring the process control data for other purposes, however, will continue, and the observed data from the continued monitoring will be evaluated for determining whether the process has returned to an acceptable zone (i.e., a return to normal for the process). A preferred embodiment continues to produce at least the values of the main scheme. Modifications may be made in the sampling intensity, if desired, for the ongoing analysis.

Block 325 begins a monitoring process that is directed toward detecting the first signs that the defect has crested, and that the data condition is beginning to improve. Until the remediation efforts begin, the data may show a worsening situation in some cases. Accordingly, as discussed above with reference to Blocks 215-200 of FIG. 2, it may be desirable in the general case to delay the analysis of the process control data, following the detection of the defect at Block 315 and setting of the alarm at Block 320 to indicate that a defect is in the Emerging phase (which corresponds generally to Block 210 of FIG. 2), so that actions directed to eliminating the defect can begin to take effect and may therefore be observed in the subsequent process control data. Block 325 corresponds to evaluating the ongoing process control data, in view of at least the main scheme, until detecting that the data condition starts improving (and corresponds generally to Block 225-235 of FIG. 2).

Once it is determined that the defect is coming under control, an embodiment of the present invention monitors for the defect to recover and for the process to thereby return to normal. The determination of a return to normal is expressed in terms of a confidence level. Accordingly, a confidence level is chosen, as shown at Block 330. The confidence level may be specific to a particular defect and/or product. As one alternative, a fixed confidence level may be used for all defects. For example, the confidence level—which may be represented using the symbol ε—may be chosen to be 0.05 (i.e., 5 percent), and in the general case, is preferably chosen to be less than 0.1 (i.e., less than 10 percent).

At any point in time following an alarm, an embodiment of the present invention computes a position of the last point in time at which the data consistent with an unacceptable process regime were observed. For example, suppose that the current point in time is T and that the data consistent with the last unacceptable regime were observed some number “M” points ago. Accordingly, the last value of the scheme corresponding to an unacceptable process regime was s_{T-M} —that is, the scheme from a point (T−M) weeks ago, when M represents some number of weeks. This point M is considered, according to an embodiment of the present invention, to be the last data segment that is relevant to establishing the current state of the process. Block 335 of FIG. 3 evaluates the process control data to locate this last change point, M. A decision on the current phase of the detected issue can then be made based on the last M values {X(i), i=T−M+1, T−M+2, . . . T}. One way in which the value of M may be determined is disclosed in the related application

An iterative analysis then begins, performing a sequential time-reversed estimation to determine whether return-to-normal conditions are present with a desired level of confidence, by setting an index value “m” to 1 at Block 340. This index value is used to sequentially step backward through the observed process control data, where this data may be considered as a window of maximum depth M. Block 345 invokes the analysis in FIG. 3B, using this value of m. The analysis performed in FIG. 3B using m will be discussed in more detail below. Block 350 tests whether the analysis is done, following the return from the processing in FIG. 3B. If not, then m is incremented at Block 355, and control returns for a next invocation of the analysis in FIG. 3B, using this now-incremented value of m.

For example, suppose that the analysis performed at Block 335 concludes that M=10—i.e., that 10 days is the estimated period of when the last bad conditions were observed for the process being analyzed, indicating that evidence of an unacceptable process were not seen after the start of that 10-day period. Whether or not this is indicative of a recovered process is analyzed by evaluating data in the window, backwards from the current time. The analysis comprising evaluating intervals within this window, in successive increments—that is, first as a 1-day interval, next as a 2-day interval, and so forth—looking backwards from the current time. Accordingly, Block 340 sets the index m to 1, so that the first iterative analysis will look at process control data from the most-recent 1-day interval, and Block 355 increments the index m so that each successive iterative analysis will look at the process control data from a next-longer, most-recent interval.

Turning now to FIG. 3B, the analysis invoked from Block 345 of FIG. 3A will now be discussed. Block 380 computes an estimate of the parameter of interest, λ_{[m]} (i.e., Lambda_{[m]}), based on the last m points—that is, for the number of samples in the interval that corresponds to the current value of m.

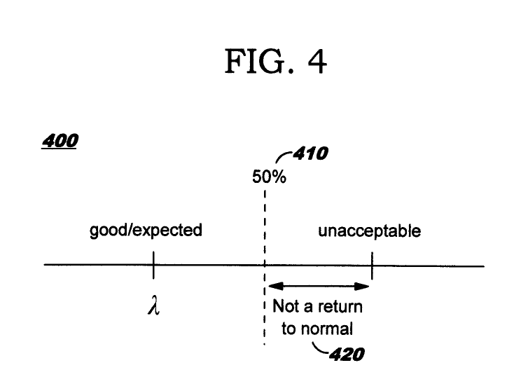

Block 382 makes a determination as to whether the estimated value lambda_{[m]} (based on the data for the last m points) is better explained as being an unacceptable process level than as being an acceptable process level, and therefore, this is not a return to normal. Stated another way, this test evaluates whether λ_{[m]} exceeds a point that is midway between λ₀ (i.e., Lambda₀) and an unacceptable level. In one embodiment, this may be measured using a Likelihood Ratio test (details of which are understood by those of skill in the art, and which are therefore not presented in detail herein). The test performed at Block 382 is illustrated by the chart 400 in FIG. 4, where exceeding midpoint 410 indicates that the data for this interval is better explained by the process being unacceptable than by the process being acceptable, as shown generally by the right-hand side 420 of chart 400. Accordingly, when the test at Block 382 has a positive result, Block 384 sets a variable or flag shown in the figures as “RTN” (for “return to normal”) to false, thereby indicating that a return to normal is not detected in the process control data. This variable will be tested at Block 350 of FIG. 3A, which is discussed below, and this setting will prevent invoking the analysis of FIG. 3B again with the current process control data.

Referring again to the example where M is a window representing 10 days of process control data, Blocks 382 and 384 correspond to determining (using the values of index m) whether any of the intervals within this 10-day period show, according to the statistical computations, that the process control data is better explained as evidence of an unacceptable process than as evidence of an acceptable process, and when any evaluated interval shows this to be true, an embodiment of the present invention concludes that the process is not recovered and exits the evaluation of the M-depth window.

If the test at Block 382 has a negative (i.e., the midway point is not exceeded for the currently-evaluated interval), then the processing of FIG. 3B continues at Block 386, using the current value of m to compute a p-value from the process control data in the current interval. In one embodiment, simulated replicas of the process are used in order to compute the p-value over a larger sample. The p-value may be computed, under the assumption that λ=λ₀, according to the following equation:

p_{[m]}=Prob {Λ_{[m]}<λ_{[m]}|wᵢ, i=T−m+1, T−m+2, . . . T, λ=λ₀}

where Λ_{[m} is the estimator based on a simulated replica of the process.

Block 388 tests whether this computed p-value for the current value of m is within the confidence interval (which was discussed above with reference to Block 330 of FIG. 3A). This may be represented using the following equation:

p_{[m]}<ε

If this test has a positive result, then an embodiment of the present invention interprets this is as sufficient confidence that the process has returned to normal. Accordingly, Block 390 sets the RTN variable to true. Block 392 then records the values (m, p_{[m]}, and λ_{[m]}) that correspond to the currently-evaluated interval, and returns those values to the invoking logic in FIG. 3A. On the other hand, when the test at Block 388 has a negative result, then it is established that the p-value for this interval is not within the confidence interval. This may be represented using the following equation:

p_{[m]}>=ε

Accordingly, a negative result at Block 388 indicates that a conclusion has not yet been reached about whether the process is recovered, and Block 392 then records the values (m, p_{[m]}, and λ_{[m]}) that correspond to the currently-evaluated interval. Control then returns to the invoking logic in FIG. 3A to determine (at Block 350) whether another iteration of FIG. 3B will be performed.

Returning now to the discussion of FIG. 3A, control returns to Block 350 following an iteration of FIG. 3B. Block 350 then determines whether FIG. 3B should be invoked again, using the next-sequential value of index m. The test at Block 350 has a negative result if the RTN variable was set to false during the processing of FIG. 3B, and also when the value of index m is already set to the maximum depth, M, for the window of process control data (indicating, in this latter case, that no more data is available for analysis by FIG. 3B). In these cases, processing continues at Block 360. Otherwise, there is additional data to evaluate, and Block 355 therefore increments the index m and control returns to Block 345 to invoke the analysis of FIG. 3B with this new value for m.

When control reaches Block 360, the variable RTN is tested. If this variable is set to true, indicating that a return to normal was detected in the analysis of FIG. 3B, then Block 365 provides a notification of recovery and this iteration of FIG. 3A is then complete. Refer to the discussion of Block 260, above, for more details regarding this notification. The recorded values (m, p_{[m]} and λ_{[m]}), which were recorded at Block 390 of FIG. 3B, are preferably included in this notification.

On the other hand, when the test at Block 360 has a negative result because the RTN variable is not set to true, then the evaluation cycle is complete but the condition (p_{[m]}<ε) was not observed for any interval m. Ongoing evaluation of the process is therefore needed, before a decision that the process is recovered can be made. Processing reaches Block 370 in this situation, which returns the values (m*, p_{[m*]}, and λ_{[m*]}) for which the smallest value of p_{[m]} was observed during the processing of FIG. 3B. These values will serve as an indicator of progress in bringing the process back to normal conditions, and may be used in a dashboard display, as has been discussed above with reference to Block 255 of FIG. 2.

When the analysis does not detect a return to normal, the analysis will be repeated after further process control data is obtained (as discussed above with reference to Blocks 245-250 of FIG. 2). Preferably, the processing of this additional data then begins at Block 335 of FIG. 3A by choosing a new value for M.

In one alternative approach, once the return to normal conditions state is established for current time T, the control scheme may be re-initiated. That is, s_{T} may be set to 0, and the process control data observed prior to the current time T can then be discarded in terms of future analysis. Or, rather than setting s_{T}=0, s_{T} may be set to a threshold h₀<h. As yet another possibility, which may be especially useful when monitoring is done on time-managed data, the analysis may continue to use the observed process control data with no resetting, and the returned values of (m, p_{[m]}, and λ_{[m]}) may be used as the main criterion for establishing how to represent the current condition of this defect on the dashboard.

In an optional enhancement, when the process is determined to not be in recovery at current time T, under the assumption that the process level is λ_{m*}, the returned values of (m*, p_{[m]}, and λ_{[m*]}) may be used to compute how large should an additional sample size be in order to obtain the condition p_{[m]}<ε (i.e., the condition that the process is recovering, within the established confidence level). The returned values may be used as input to a simulation process, or a statistical computation process, to make this determination.

A number of modifications may be made to the approach shown in FIGS. 3A-3B for declaring a return to normal, without deviating from the scope of the present invention. As one example, the midway point used for the test at Block 382 may be as follows:

λ_{*}=(λ₁−λ₀)/ln(λ₁/λ₀)

This value for λ_{*} is close to the midway, but its use offers some statistical advantages that are related to superior power offered by Likelihood Ration detection methodologies. As another example, the requirement that the p-value is less than λ₀ could be replaced by a more general value shown by the following equation:

λ₀ᵢₙₜ=λ₀+intv(λ₈−λ₀)

where “intv” in this equation represents a value selected from the interval [0, 1] as the level that is needed before confidently declaring that the process is recovered. Note that for intv=0, this level is λ₀ and for intv=1, this value is λ_{*}, so that λ_{*} will never be exceeded.

Turning now to FIG. 5, an alternative version of the processing in FIG. 3B is provided. This alternative version differs in that the p-value is not computed for each interval m, and instead is only computed when analyzing the entire window of depth M. See Block 585, which tests whether index m is currently set to M, and if not, exits from this iteration. When the test at Block 585 has a positive result, on the other hand, then Block 587 computes the p-value in the same manner discussed above with reference to Block 386 of FIG. 3B, but now using the M instead of an intermediate value m. If the p-value computed for M is within the confidence level (that is, when p_{M}<ε), then Block 593 returns the values (M, p_{M}, and λ_{M}) instead of the values which were returned at Block 392 of FIG. 3B.

An optional enhancement to the logic of FIG. 3B uses a code that represents a “degree of forgiveness” (i.e., a degree of return to normal), where this code is assigned based on how the data is analyzed. A code of integers 1, 2, . . . 9 might be used, for example, where 9 corresponds to successfully establishing a return to normal and 1 corresponds to the lowest degree of return to normal. In case all of the test conditions are completely satisfied, the value of 9 is assigned to the code. If the condition p_{M}<ε is satisfied, but Block 382 has a positive result for any value of m, then the code might be set to 8. If (ε=<p_{M}<2*ε) is satisfied and Block 382 has a negative result for every interval m, the code might be set to 7. If (ε=<p_{M}<2*ε) is satisfied but Block 382 has a positive result for some interval m, the code might be set to 6, and so forth. The value of the code could then be used to indicate the degree of return to normal on the dashboard.

Referring back to the defect life cycle graph in FIG. 1, the phases of defect development can be evaluated (and visualized) based on the trajectory of a control scheme, which have been discussed above. Once an alarm is triggered, the emerging phase is entered and defect management begins. The crest of the defect is evaluated based on the peak of a post-alarm trajectory of the control scheme. Improvements and degradation periods correspond to points of growth and decrease in the values of the control scheme. An embodiment of the present invention continues to analyze process control data, using techniques described above, measuring the degree of recovery in terms of (m*, p_{[m*]}, and λ_{[m*]}) until enough evidence is available to declare that the process is recovered. At that point, monitoring begins anew (e.g., to detect a different defect).

It can be seen, in view of the above disclosure, that analysis for detecting a defect and the analysis for detecting the return-to-normal condition are asymmetric. In the first case, the decision to flag the process as non-conformant (i.e., in the emerging phase, where a defect has been detected) is made based on the fact that the process control data is explained better by an unacceptable process than by an acceptable process. This is because defect remediation efforts should be started sooner, rather than waiting for proof that the underlying process level is indeed unacceptable. In the second case, however, the return to normal state is only declared once there is a statistical proof, at a given level of confidence, that the underlying process is indeed acceptable. In other words, the burden of proof is decidedly shifted to the process owner.

As has been demonstrated, an embodiment of the present invention provides a predictable, and high, level of statistical power. The system will not linger unnecessarily long in the abnormal condition; at the same time, it will not declare a return to normal until a sufficient amount of supporting evidence has been accumulated. An embodiment of the present invention also handles decisions within a unified statistical framework, and does not require additional graphical instrumentation. Instead, all information needed for decision-making may be provided in the returned values (e.g., a return code indicating whether recovery is complete). At the same time, an embodiment of the present invention enables presenting graphical evidence to support the statement about the current state of the process, regardless of the phase of the defect life cycle. An embodiment of the present invention may be used with irregular (e.g., time-delayed reporting, time-managed) data streams, and may be used with highly-efficient simulation processes for establishing degrees of confidence. An embodiment of the present invention may be configured relatively easy, and may require only one parameter (i.e., the required degree of confidence) to be input by a process control professional. Determining the last data segment that is relevant to establishing the current state of the process provides additional efficiency, because this segment is typically only a small fraction of the overall data volume, thereby providing a high level of computational efficiency and enabling more efficient processing in view of possibly massive amounts of data. In addition, an embodiment of the present invention provides statistically meaningful progress indicators on the degree of return to normal, and these indicators may be used to forecast the amount of time needed before the process returns to normal.

While preferred embodiments have been discussed above primarily to using secondary tests for analyzing change in the non-conformance rate for a process, the disclosed techniques may also be used generalized to other types of detection procedures without deviating from the scope of the present invention. For example, alternative tests may be used with observed process control data for detecting drift, which is a gradual change in a process, or to detecting shift, which is a sudden change in the process. Or, alternative tests may be used with the observed process control data to detect wobbling, which corresponds to a change in variability rather than a change in the fall-out rate, where a change in variability may signal an impending problem.

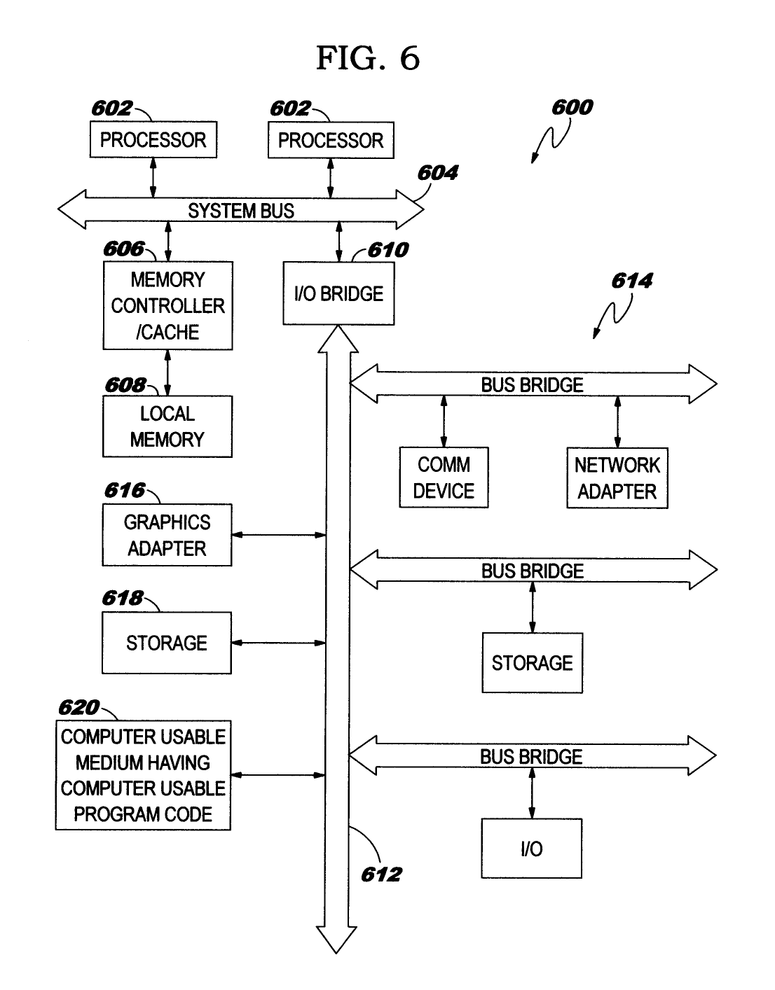

Referring now to FIG. 6, a block diagram of a data processing system is depicted in accordance with the present invention. Data processing system 600, such as one of the processing devices described herein, may comprise a symmetric multiprocessor (“SMP”) system or other configuration including a plurality of processors 602 connected to system bus 604. Alternatively, a single processor 602 may be employed. Also connected to system bus 604 is memory controller/cache 606, which provides an interface to local memory 608. An I/O bridge 610 is connected to the system bus 604 and provides an interface to an I/O bus 612. The I/O bus may be utilized to support one or more buses 614 and corresponding devices, such as bus bridges, input output devices (“I/O” devices), storage, network adapters, etc. Network adapters may also be coupled to the system to enable the data processing system to become coupled to other data processing systems or remote printers or storage devices through intervening private or public networks.

Also connected to the I/O bus may be devices such as a graphics adapter 616, storage 618, and a computer usable storage medium 620 having computer usable program code embodied thereon. The computer usable program code may be executed to execute any aspect of the present invention, as have been described herein.

The data processing system depicted in FIG. 6 may be, for example, an IBM System p® system, a product of International Business Machines Corporation in Armonk, N.Y., running the Advanced Interactive Executive (AIX®) operating system. An object-oriented programming system such as Java may run in conjunction with the operating system and provides calls to the operating system from Java® programs or applications executing on data processing system. Processing may also be performed by using non-object-oriented environments and high-level computing languages, such as Perl or Fortran. (“System p” and “AIX” are registered trademarks of International Business Machines Corporation in the United States, other countries, or both. “Java” is a registered trademark of Sun Microsystems, Inc., in the United States, other countries, or both.)

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit”, “module”, or “system”. Furthermore, aspects of the present invention may take the form of a computer program product embodied in one or more computer readable media having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (“RAM”), a read-only memory (“ROM”), an erasable programmable read-only memory (“EPROM” or flash memory), a portable compact disc read-only memory (“CD-ROM”), DVD, an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency, etc., or any suitable combination of the foregoing.

Computer program code for carrying out operations for aspects of the present invention may be written in any combination of one or more programming languages, including an object oriented programming language such as Java, Smalltalk, C++, or the like, and conventional procedural programming languages such as the “C” programming language or similar programming languages. The program code may execute as a stand-alone software package, and may execute partly on a user's computing device and partly on a remote computer. The remote computer may be connected to the user's computing device through any type of network, including a local area network (“LAN”), a wide area network (“WAN”), or through the Internet using an Internet Service Provider.

Aspects of the present invention are described above with reference to flow diagrams and/or block diagrams of methods, apparatus (systems), and computer program products according to embodiments of the invention. It will be understood that each flow or block of the flow diagrams and/or block diagrams, and combinations of flows or blocks in the flow diagrams and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow diagram flow or flows and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flow diagram flow or flows and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flow diagram flow or flows and/or block diagram block or blocks.

Flow diagrams and/or block diagrams presented in the figures herein illustrate the architecture, functionality, and operation of possible implementations of systems, methods, and computer program products according to various embodiments of the present invention. In this regard, each flow or block in the flow diagrams or block diagrams may represent a module, segment, or portion of code, which comprises one or more executable instructions for implementing the specified logical function(s). It should also be noted that, in some alternative implementations, the functions noted in the flows and/or blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or each flow of the flow diagrams, and combinations of blocks in the block diagrams and/or flows in the flow diagrams, may be implemented by special purpose hardware-based systems that perform the specified functions or acts, or combinations of special purpose hardware and computer instructions.

While embodiments of the present invention have been described, additional variations and modifications in those embodiments may occur to those skilled in the art once they learn of the basic inventive concepts. Therefore, it is intended that the appended claims shall be construed to include the described embodiments and all such variations and modifications as fall within the spirit and scope of the invention.

1. A computer-implemented method of analyzing trends in a process control environment, comprising:
determining, by applying at least one defect-detecting analysis scheme to first observed process control data for a process entity, when the process entity exhibits a defect during a process; and
determining, by applying at least one recovery-detecting analysis scheme to second observed process control data for the process entity, whether the process entity is recovered from the defect.

2. The method according to claim 1, wherein the recovery-detecting analysis scheme comprises:
determining a point in time where the second observed process control data trends toward recovery from the defect.

3. The method according to claim 2, wherein the recovery-detecting analysis scheme further comprises:
analyzing the second observed process control data for a time period following the determined point in time to determine if the process entity is recovered from the defect.

4. The method according to claim 3, wherein:
the time period comprises an interval from the determined point in time to a current time, and
the analyzing further comprises:
creating a plurality of sequences from the second observed process control data to compute a parameter value, over a period extending backwards from the current time to the point in time, each of the sequences corresponding to a different subset of the interval and extending backwards from the current time to a successively earlier point during the interval; and
analyzing, using each of the plurality of sequences, a subset of the second process control data to compute the parameter value for the subset, each of the subsets of the second process control data representing process control data observed during the subset of the time interval that corresponds to the sequence.

5. The method according to claim 4, further comprising:
computing, from the parameter value for each the subsets of the interval, a statistical p-value corresponding to the subset;
computing, from the p-values corresponding to the subsets, a p-value corresponding to the plurality of sequences; and
determining that the process entity is recovered from the defect if the computed p-value for the plurality of sequences falls within a predetermined confidence interval.

6. The method according to claim 4, further comprising:
computing, from the parameter values for the subsets of the interval, a statistical p-value corresponding to the subset; and
determining that the process entity is recovered from the defect if the computed p-value for any of the plurality of sequences falls within a predetermined confidence interval.

7. The method according to claim 1, wherein the defect-detecting analysis scheme comprises:
determining a slope of an evidence curve created from the first process control data; and
determining that the process entity exhibits the defect during the process when the slope increases beyond a predetermined confidence level.

8. The method according to claim 1, further comprising:
receiving a first return code from the determining whether the defect is detected;
receiving a second return code from the determining whether the process entity is recovered; and
rendering, on a visual display for the process, a graphical representation for the first return code and the second return code.

9. The method according to claim 1, further comprising:
issuing a notification, responsive to determining that the process entity is recovered, for cessation of a remediation effort initiated responsive to determining that the detect is detected.

10. The method according to claim 1, further comprising:
receiving a first result from the determining whether the defect is detected;
receiving a second result from the determining whether the process entity is recovered; and
determining, from the first result and the second result, a current life cycle phase of the defect.
